(19) United States
(12) Patent Application Publication
(10) Pub. No.: US 2013/0290848 A1
(43) Pub. Date: Oct. 31, 2013

(54) CONNECTED MULTI-SCREEN VIDEO

(71) Applicants: Allen Billings, Lafayette, CA (US); Kirsten Hunter, San Francisco, CA (US); Ray De Renzo, Walnut Creek, CA (US); Dan Gardner, New York, NY (US); Michael Treff, Brooklyn, NY (US); Christopher Hall, Brooklyn, NY (US); Tommy Kuntze, Oakland, CA (US); Jesse Wang, New York, NY (US)

(72) Inventors: Allen Billings, Lafayette, CA (US); Kirsten Hunter, San Francisco, CA (US); Ray De Renzo, Walnut Creek, CA (US); Dan Gardner, New York, NY (US); Michael Treff, Brooklyn, NY (US); Christopher Hall, Brooklyn, NY (US); Tommy Kuntze, Oakland, CA (US); Jesse Wang, New York, NY (US)

(73) Assignee: MobiTV, Inc., Emeryville, CA (US)

(21) Appl. No.: 13/587,441

(22) Filed: Aug. 16, 2012

Related U.S. Application Data
(60) Provisional application No. 61/639,689, filed on Apr. 27, 2012.

(51) Int. Cl. G06F 3/01

(52) U.S. Cl. 715/719

(57) ABSTRACT

Disclosed herein are techniques and mechanisms for providing a connected multi-screen interface. According to various embodiments, a system may include a media presentation server. The media presentation server may include a processor and memory. The media presentation server may be operable to transmit information for generating a media presentation interface at a plurality of media presentation devices. The media presentation interface may be operable to navigate and display media content. The system may also include a first and a second media presentation device. Each media presentation device may include a processor, memory, and a display screen. Each media presentation device may be operable to generate the media presentation interface based on the information received from the media presentation interface server. The second media presentation device may be operable to update the media presentation interface based on an instruction received from the first media presentation device.

### CROSS-REFERENCE TO RELATED APPLICATIONS

This application claims priority to Provisional U.S. Patent Application No. 61/639,689 by Billings et al., filed Apr. 27, 2012, titled “CONNECTED MULTI-SCREEN VIDEO”, which is hereby incorporated by reference in its entirety and for all purposes.

### TECHNICAL FIELD

The present disclosure relates to connected multi-screen video.

### DESCRIPTION OF RELATED ART

A variety of devices in different classes are capable of receiving and playing video content. These devices include tablets, smartphones, computer systems, game consoles, smart televisions, and other devices. The diversity of devices combined with the vast amounts of available media content have created a number of different presentation mechanisms.

However, mechanisms for providing common experiences across different device types and content types are limited. Consequently, the techniques of the present invention provide mechanisms that allow users to have improved experiences across devices and content types.

### BRIEF DESCRIPTION OF THE DRAWINGS

The disclosure may best be understood by reference to the following description taken in conjunction with the accompanying drawings, which illustrate particular embodiments.

FIGS. 1 and 2 illustrate examples of systems that can be used with various techniques and mechanisms of the present invention.

FIGS. 3-15 illustrate images of examples of user interfaces.

FIGS. 16-22 illustrate examples of techniques for communicating between various devices.

FIG. 23 illustrates one example of a system.

FIG. 25 illustrates an example of a media delivery system.

FIG. 25 illustrates examples of encoding streams.

FIG. 26 illustrates one example of an exchange used with a media delivery system.

FIG. 27 illustrates one technique for generating a media segment.

FIG. 28 illustrates one example of a system.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Disclosed herein are mechanisms and techniques that may be used to provide a connected, multi-screen user interface. Users may employ various types of devices to view media content such as video and audio. The devices may be used alone or together to present the media content. The media content may be received at the devices from various sources. According to various embodiments, different devices may communicate to present a common interface across the devices.

### Example Embodiments

According to various embodiments, a connected multi-screen system may provide a common experience across devices while allowing multi-screen interactions and navigation. Content may be organized around content entities such as shows, episodes, sports categories, genres, etc. The system includes an integrated and personalized guide along with effective search and content discovery mechanisms. Co-watching and companion information is provided to allow for social interactivity and metadata exploration.

According to various embodiments, a connected multi-screen interface is provided to allow for a common experience across devices in a way that is optimized for various device strengths. Media content is organized around media entities such as shows, programs, episodes, characters, genres, categories, etc. In particular embodiments, live television, on-demand, and personalized programming are presented together. Multi-screen interactions and navigation are provided with social interactivity, metadata exploration, show information, and reviews.

According to various embodiments, a connected multi-screen interface may be provided on two or more display screens associated with different devices. The connected interface may provide a user experience that is focused on user behaviors, not on a particular device or service. In particular embodiments, a user may employ different devices for different media-related tasks. For instance, a user may employ a television to watch a movie while using a connected tablet computer to search for additional content or browse information related to the movie.

According to various embodiments, a connected interface may facilitate user interaction with content received from a variety of sources. For instance, a user may receive content via a cable or satellite television connection, an online video-on-demand provider such as Netflix, a digital video recorder (DVR), a video library stored on a network storage device, and an online media content store such as iTunes or Amazon. Instead of navigating and searching each of these content sources separately, a user may be presented with a digital content guide that combines content from the different sources. In this way, a user can search and navigate content based on the user's preferences without being bound to a particular content source, service, or device.

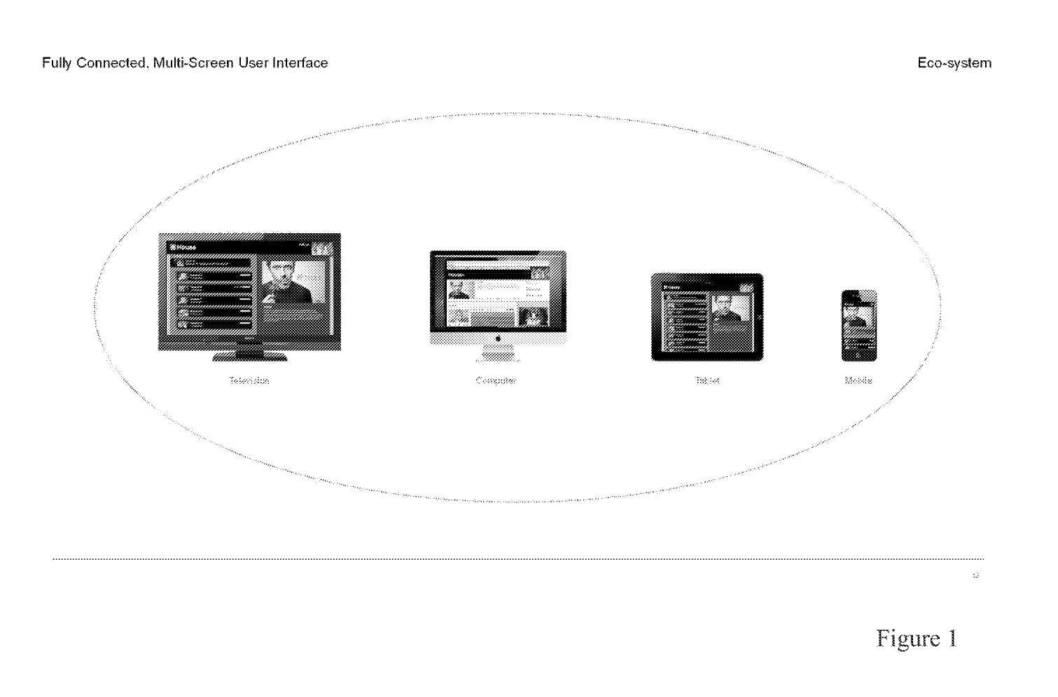

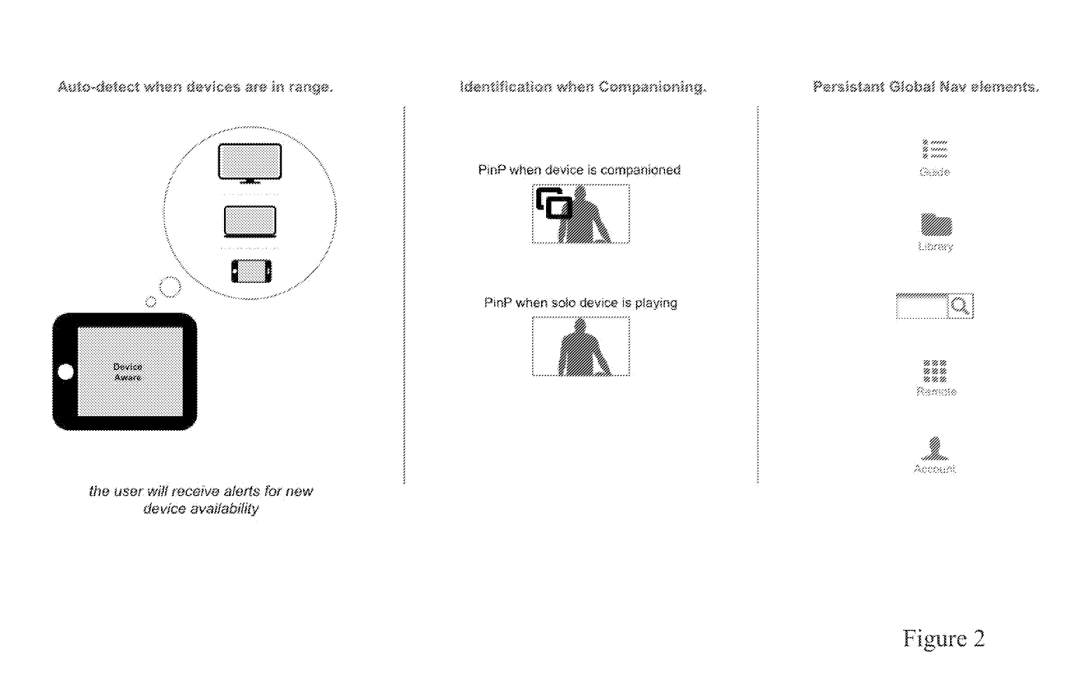

FIGS. 1 and 2 illustrate examples of systems that can be used with various techniques and mechanisms of the present invention. As shown in FIG. 1, various devices may be used to view a user interface for presenting and/or interacting with content. According to various embodiments, one or more conventional televisions, smart televisions, desktop computers, laptop computers, tablet computers, or mobile devices such as smart phones may be used to view a content-related user interface.

According to various embodiments, a user interface for presenting and/or interacting with media content may include various types of components. For instance, a user interface may include one or more media content display portions, user interface navigation portions, media content guide portions, related media content portions, media content overlay portions, web content portions, interactive application portions, or social media portions.

According to various embodiments, the media content displayed on the different devices may be of various types and/or derive from various sources. For example, media content may be received from a local storage location, a network storage location, a cable or satellite television provider, an Internet content provider, or any other source. The media content may include audio and/or video and may be television, movies, music, online videos, social media content, or any other content capable of being accessed via a digital device.

As shown in FIG. 2, devices may communicate with each other. According to various embodiments, devices may communicate directly or through another device such as a network gateway or a remote server. In some instances, communications may be initiated automatically. For example, an active device that comes within range of another device that may be used in conjunction with techniques described herein may provide an alert message or other indication of the possibility of a new connection. As another example, an active device may automatically connect with a new device within range.

According to various embodiments, a user interface may include one or more portions that are positioned on top of another portion of the user interface. Such a portion may be referred to herein as a picture in picture, a PinP, an overlaid portion, an asset overlay, or an overlay.

According to various embodiments, a user interface may include one or more navigation elements, which may include, but are not limited to: a media content guide element, a library element, a search element, a remote control element, and an account access element. These elements may be used to access various features associated with the user interface, such as a search feature or media content guide feature.

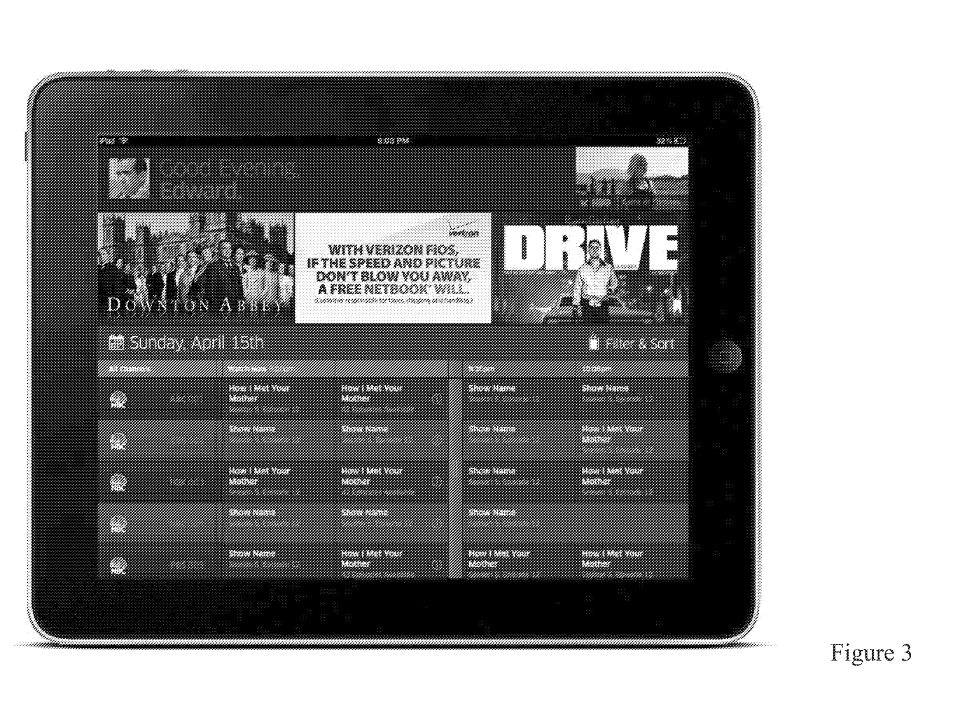

FIGS. 3-15 illustrate images of examples of user interfaces. According to various embodiments, the user interfaces shown may be presented on any of various devices. In some cases, user interfaces may appear somewhat differently on different devices. For example, different devices may have different screen display resolutions, screen display aspect ratios, and user input device capabilities. Accordingly, a user interface may be adapted to a particular type of device.

FIG. 3 illustrates an image of an example of a program guide user interface. According to various embodiments, a program guide user interface may be used to identify media content items for presentation. The program guide may include information such as a content title, a content source, a presentation time, an example video feed, and other information for each media content item. The program guide may also include other information, such as advertisements and filtering and sorting elements.

According to various embodiments, the techniques and mechanisms described herein may be used in conjunction with grid-based electronic program guides. In many grid-based electronic program guides, content is organized into “channels” that appear on one dimension of the grid and time that appears on the other dimension of the grid. In this way, the user can identify the content presented on each channel during a range of time.

According to various embodiments, the techniques and mechanisms described herein may be used in conjunction with mosaic programming guides. In mosaic programming guides, a display includes panels of actual live feeds as a channel itself. A user can rapidly view many options at the same time. Using the live channel as a background, a lightweight menu-driven navigation system can be used to position an overlay indicator to select video content. Alternatively, numeric or text based navigation schemes could also be used. Providing a mosaic of channels in a single channel instead of merging multiple live feeds into a single display decreases complexity of a device application. Merging multiple live feeds require individual, per channel feeds of content to be delivered and processed at an end user device. Bandwidth and resource usage for delivery and processing of multiple feeds can be substantial. Less bandwidth is used for a single mosaic channel, as a mosaic channel would simply require a video feed from a single channel. The single channel could be generated by content providers, service providers, etc.

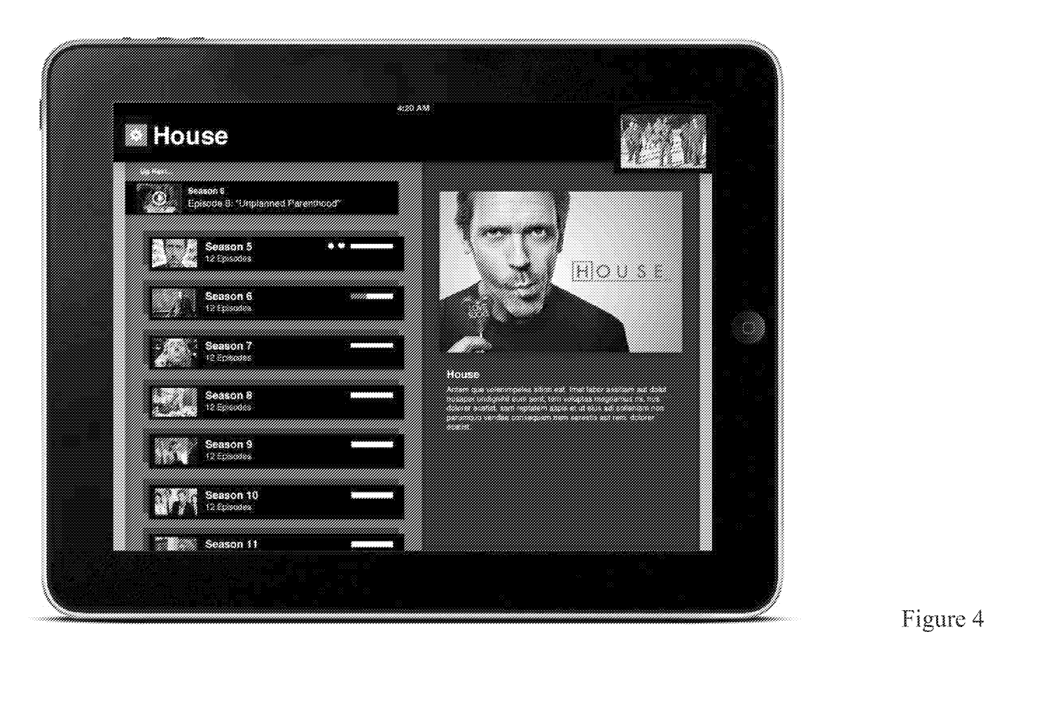

FIG. 4 illustrates an image of an example of a user interface for accessing media content items. According to various embodiments, a media content item may be a media content entity or a media content asset. A media content asset may be any discrete item of media content capable of being presented on a device. A media content entity may be any category, classification, container, or other data object capable of containing one or more media content assets or other media content entities. For instance, in FIG. 4, the television show “House” is a media content entity, while an individual episode of the television show “House” is a media content asset.

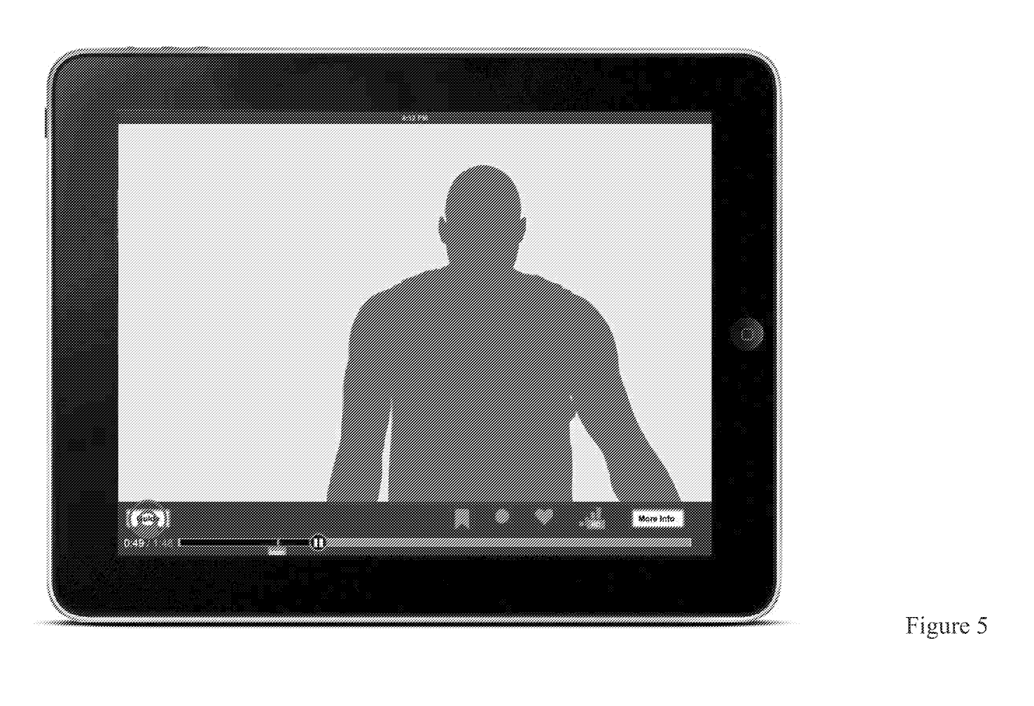

FIG. 5 illustrates an image of an example of a media content playback user interface. According to various embodiments, a media content playback user interface may facilitate the presentation of a media content item. The media content playback user interface may include features such as one or more media content playback controls, media content display areas, and media content playback information portions.

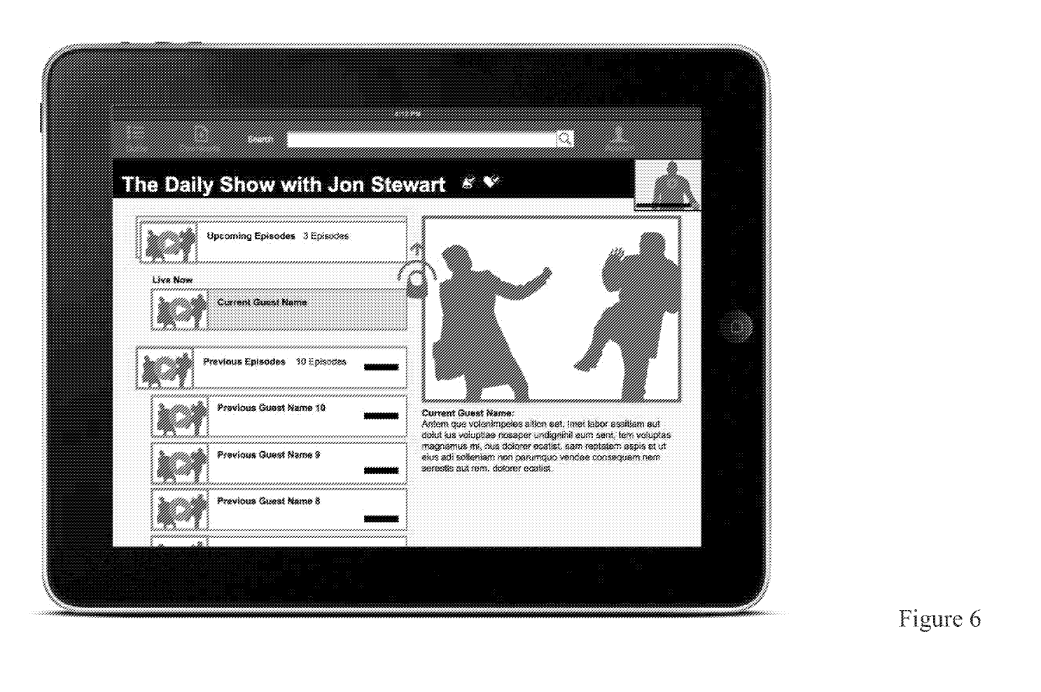

FIG. 6 illustrates an example of a global navigation user interface. According to various embodiments, the global navigation user interface may be used to display information related to a media content item. For instance, the example shown in FIG. 6 includes information related, to the media content entity “The Daily Show with Jon Stewart.” In this case, the related information includes links or descriptions of previous and upcoming episodes as well as previous, current, and upcoming guest names. However, a global navigation user guide may display various types of related information, such as cast member biographies, related content, and content ratings. As with many other user interfaces described herein, the global navigation user guide may include an asset overlay for presenting a media clip, which in the example shown in FIG. 6 is displayed in the upper right corner of the display screen. The asset overlay may display content such as a currently playing video feed, which may also be presented on another device such as a television.

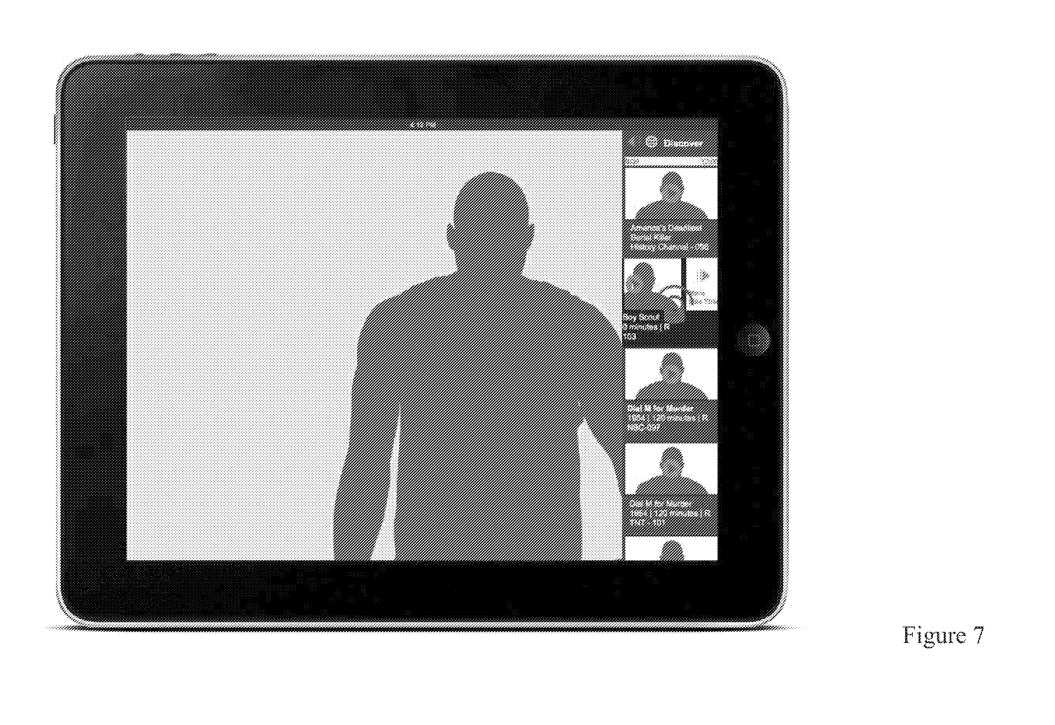

FIG. 7 illustrates an example of a discovery panel user interface within an overlay that appears in front of a currently playing video. According to various embodiments, the discovery panel user interface may include suggestions for other content. For instance, the discovery panel user interface may include information regarding content suggested based on an assumed preference for the content currently being presented. If a television program is being shown, the discovery panel may include information such as movies or other television programs directed to similar topics, movies or television programs that share cast members with the television program being shown, and movies or television programs that often reflect similar preferences to the television program being shown.

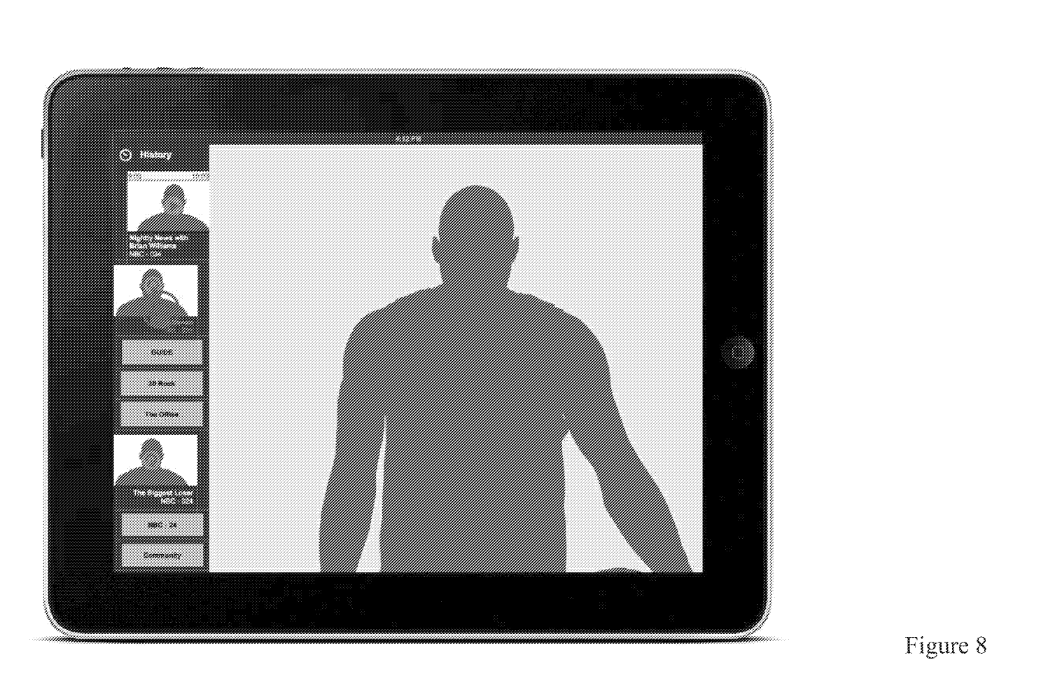

FIG. 8 illustrates an example of a history panel user interface within an overlay that appears in front of a currently playing video. According to various embodiments, the history panel user interface may include information regarding media content items that have been presented in the past. The history panel user interface may display various information regarding such media content items, such as thumbnail images, titles, descriptions, or categories for recently viewed content items.

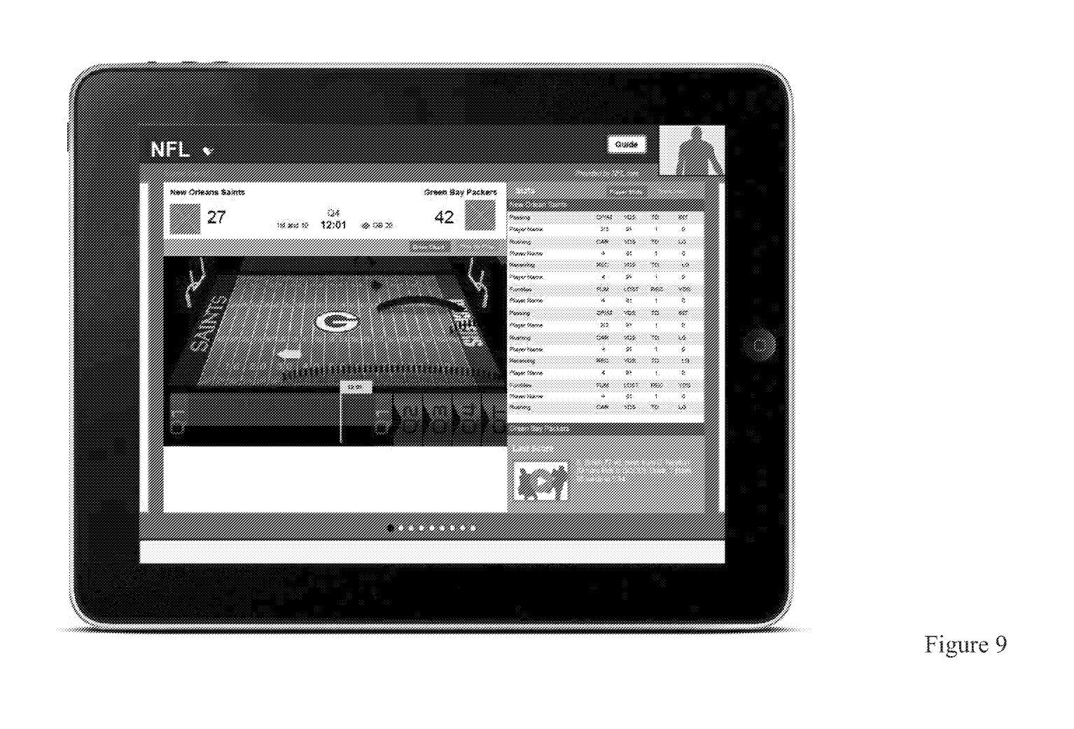

FIG. 9 illustrates an example of an asset overlay user interface configured for companion or co-watching. According to various embodiments, an asset overlay user interface may display information related to content being presented. For example, a user may be watching a football game on a television. At the same time, the user may be viewing related information on a tablet computer such as statistics regarding the players, the score of the game, the time remaining in the game, and the teams' game playing schedules. The asset overlay user interface that presents a smaller scale version of the content being presented on the other device.

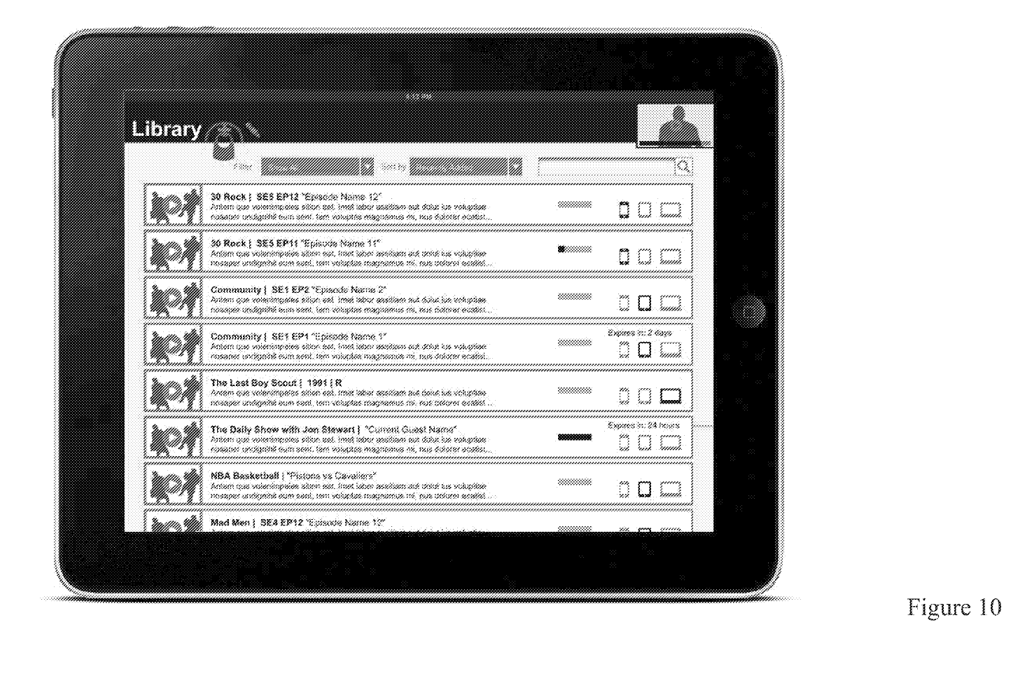

FIG. 10 illustrates an image of an example of a library user interface. According to various embodiments, the library user interface may be used to browse media content items purchased, downloaded, stored, flagged, or otherwise acquired for playback in association with a user account. The library user interface may include features such as one or more media content item lists, media content item list navigation elements, media content item filtering, sorting, or searching elements. The library user interface may display information such as a description, categorization, or association for each media content item. The library user interface may also indicate a device on which the media content item is stored or may be accessed.

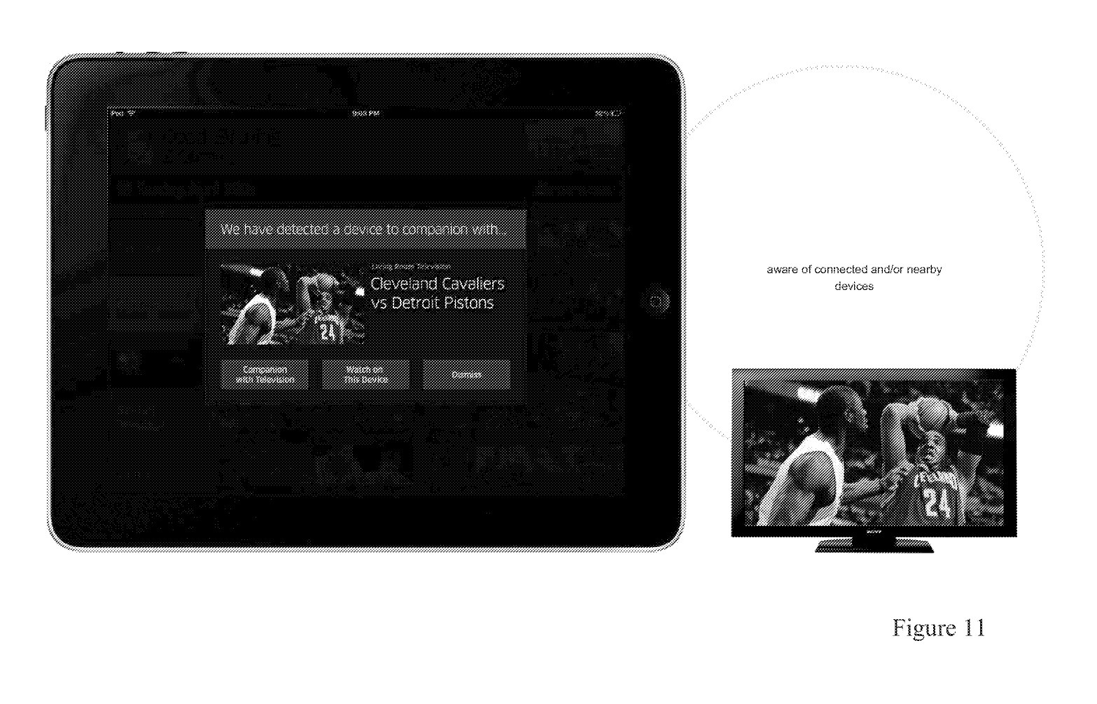

FIGS. 11-15 illustrate images of examples of a connected user interface displayed across two devices. In FIG. 11, a sports program is presented on a television while a content guide is displayed on a tablet computer. Because the television is capable of connecting with the tablet computer, the tablet computer presents an alert message that informs the user of the possibility of connecting. Further, the alert message allows the user to select an option such as watching the television program on the tablet computer, companioning with the television to view related information on the tablet computer, or dismissing the connection.

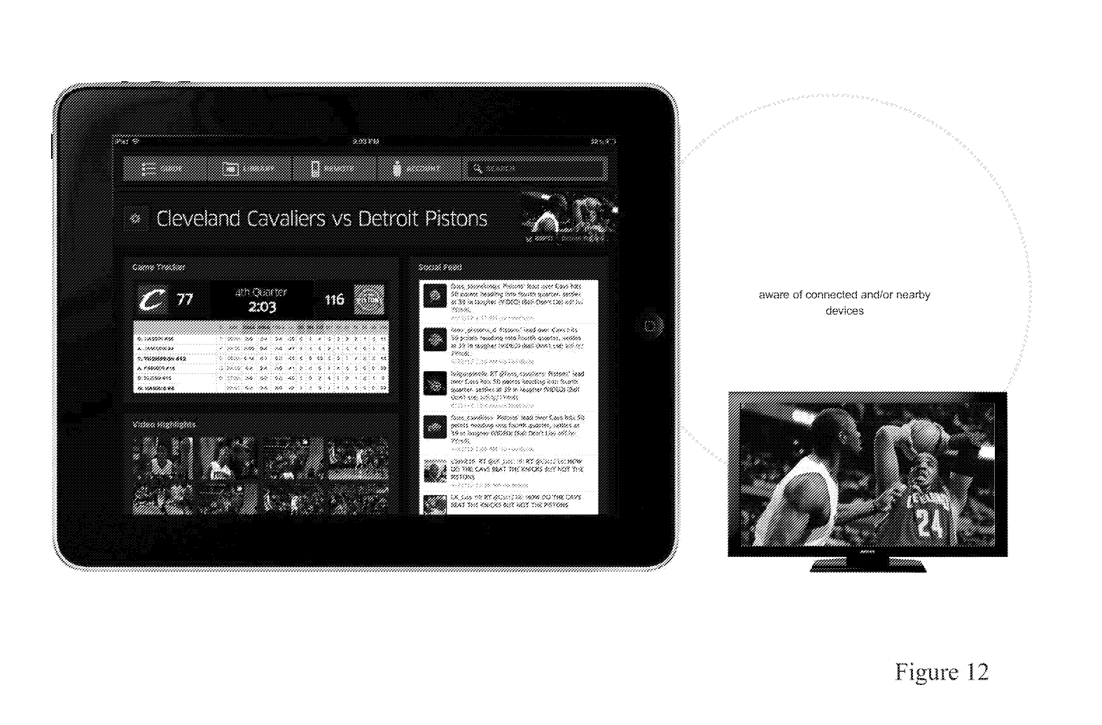

In FIG. 12, the tablet computer is configured for companion viewing. In companion viewing mode, the tablet computer may display information related to the content displayed on the television. For instance, in FIG. 12, the tablet computer is displaying the score of the basketball game, social media commentary related to the basketball game, video highlights from the game, and play statistics. In addition, the tablet computer displays a smaller, thumbnail image sized video of the content displayed on the television.

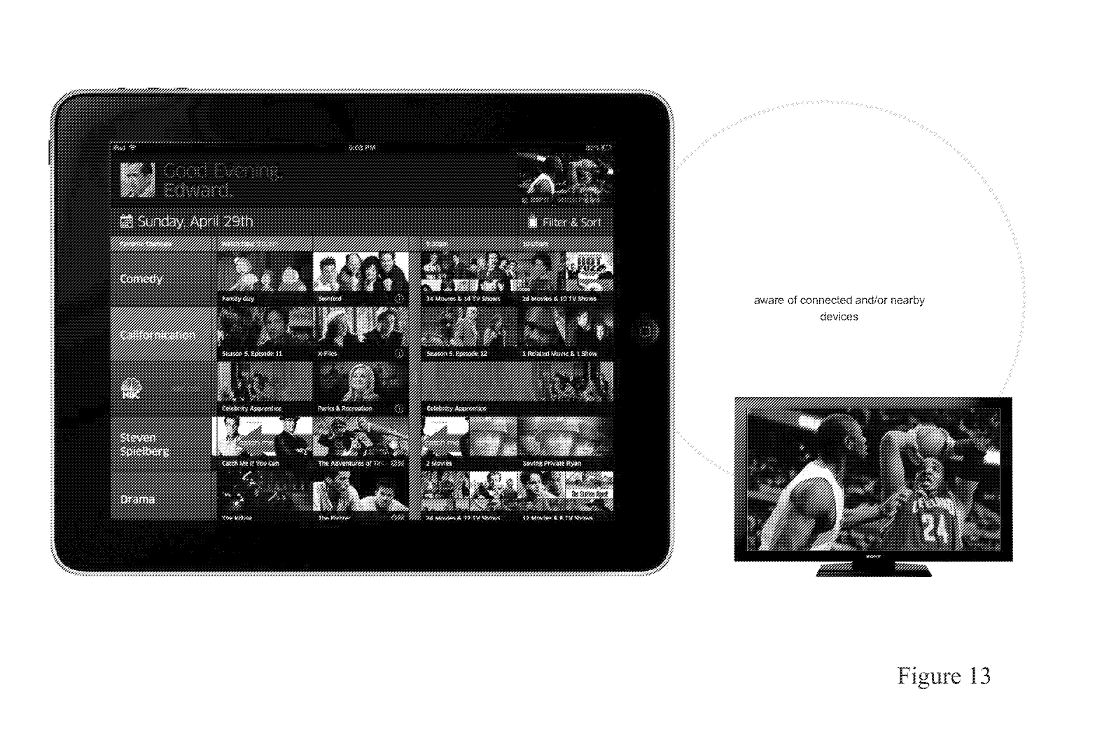

In FIG. 13, the user browses for new content while continuing to view the basketball game in companion mode across the two devices. Accordingly, the tablet computer displays a content guide for selecting other content while continuing to display the smaller, thumbnail image sized video of the basketball game displayed on the television.

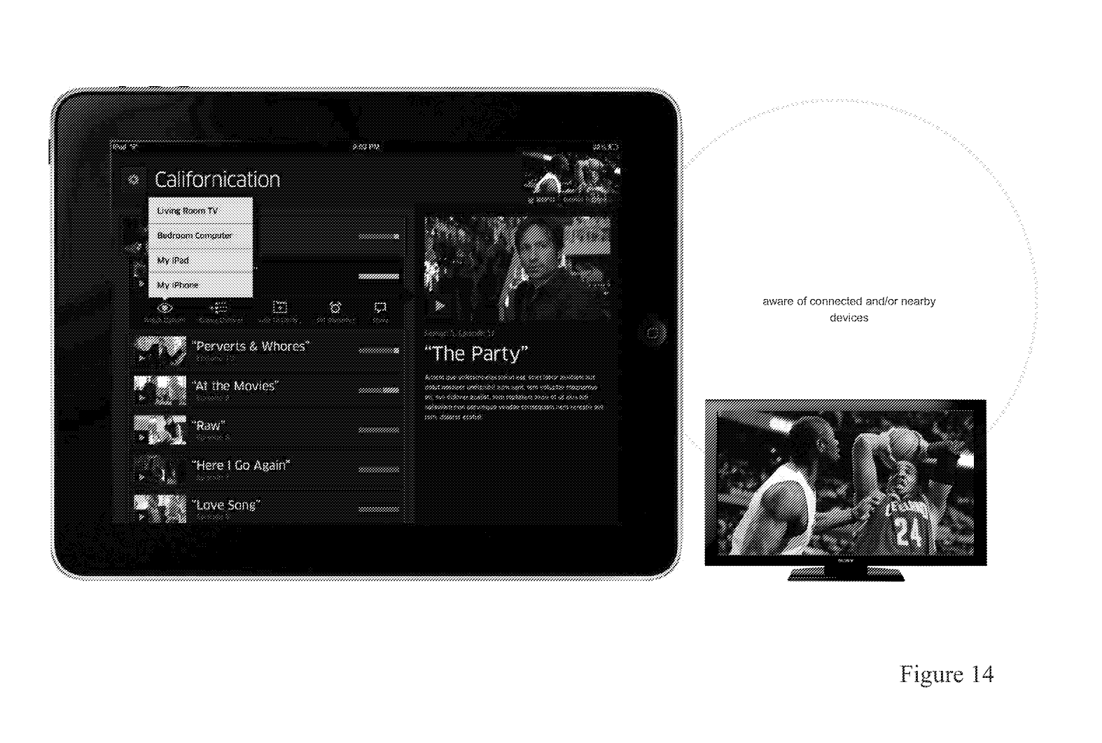

In FIG. 14, the user is in the process of selecting a new media content item for display. Here the new media content item is a television episode called “The Party.” After selecting the media content item, the user may select a device for presenting the content. In FIG. 14, the available devices for selection include the Living Room TV, the Bedroom Computer. My iPad, and My iPhone. By allowing control of content across different devices, the connected user interface can provide a seamless media viewing experience.

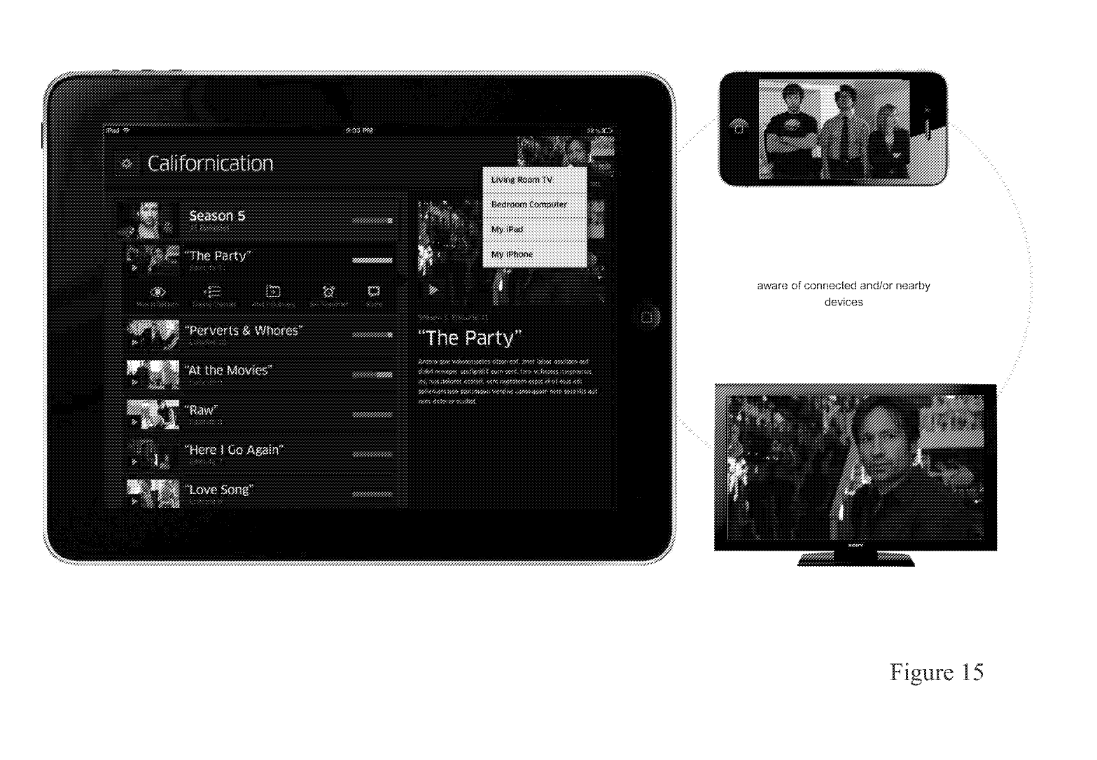

In FIG. 15, the user has selected to view the new television program on the Living Room TV. Additionally, a new device, which is a mobile phone, has entered the set of connected and/or nearby devices. By selecting the device within the user interface, the user can cause the currently playing video to also display on the mobile phone. In this way, the user can continue a video experience without interruption even if the user moves to a different physical location. For example, a user may be watching a television program on a television while viewing related information on a tablet computer. When the user wishes to leave the house, the user may cause the television program to also display on a mobile phone, which allows the user to continue viewing the program.

It should be noted that the user interfaces shown in FIGS. 3-15 are only examples of user interfaces that may be presented in accordance with techniques and mechanisms described herein. According to various embodiments, user interfaces may not include all elements shown in FIGS. 3-15 or may include other elements not shown in FIGS. 3-15. By the same token, the elements of a user interface may be arranged differently than shown in FIGS. 3-15. Additionally, user interfaces may be used to present other types of content, such as music, and may be used in conjunction with other types of devices, such as personal or laptop computers.

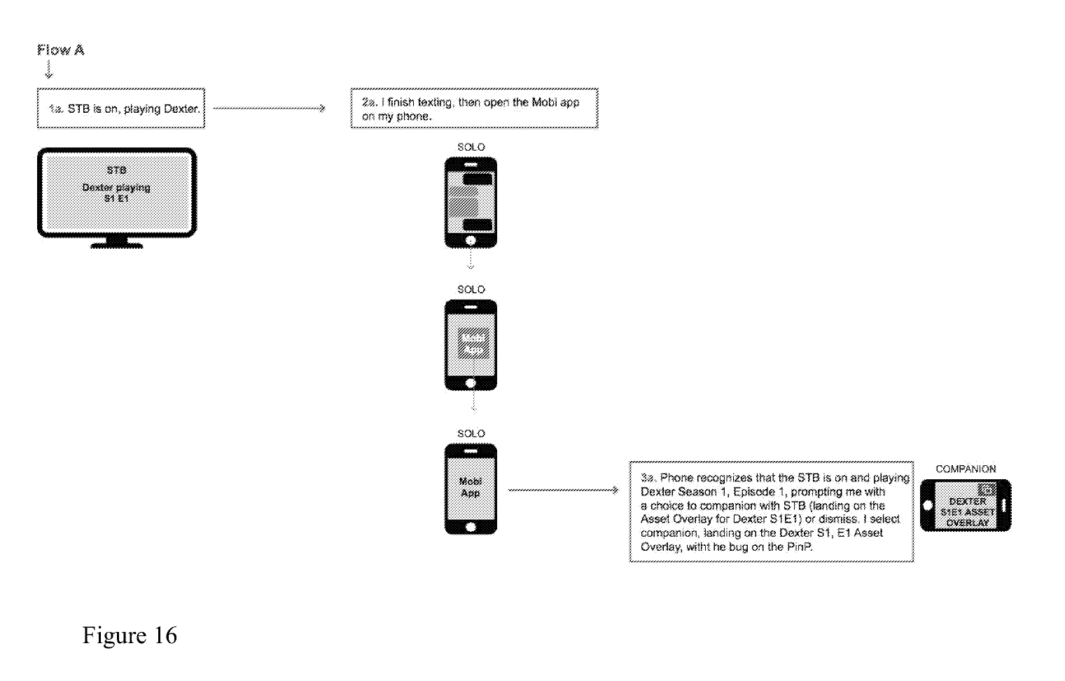

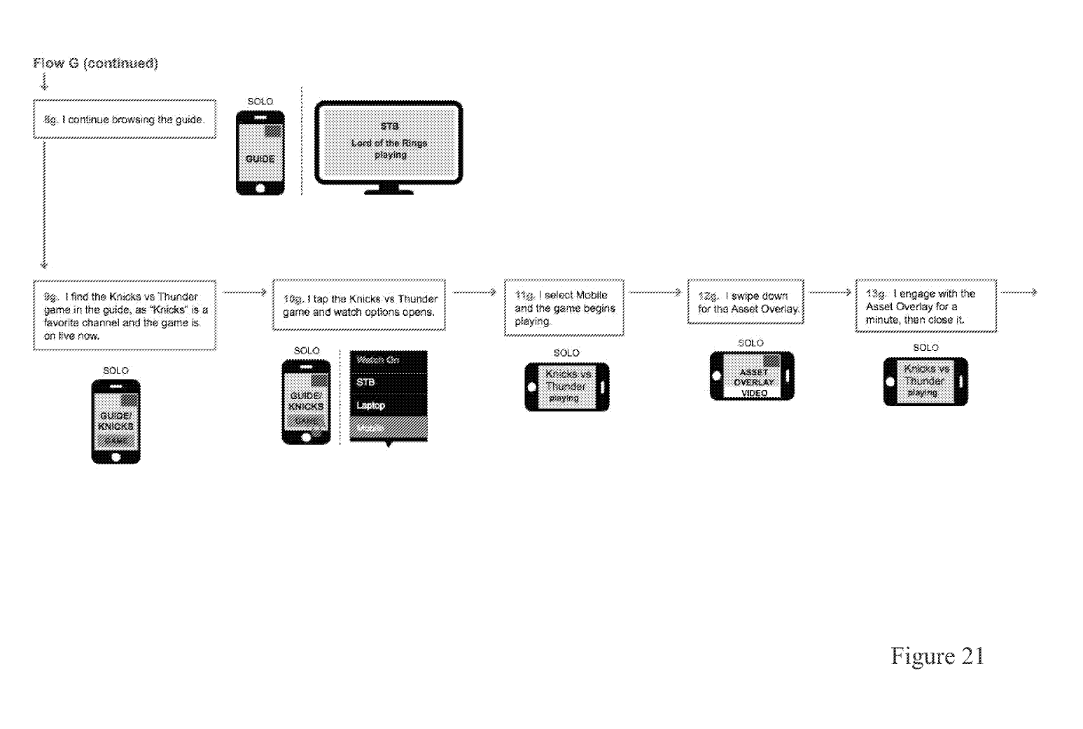

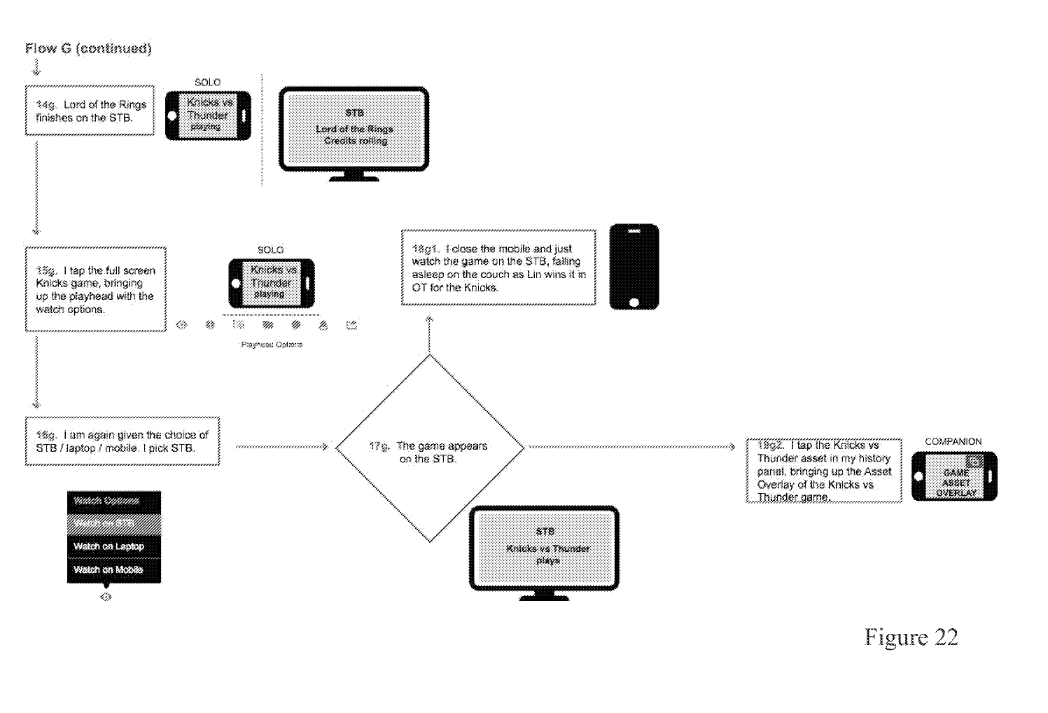

FIGS. 16-22 illustrate examples of techniques for communicating between various devices. In FIG. 16, a mobile device enters companion mode in communication with a television. According to various embodiments, companion mode may be used to establish a connected user interface across different devices. The connected user interface may allow a user to control presentation of media content from different devices, to view content across different devices, to retrieve content from different devices, and to access information or applications related to the presentation of content.

At operation 1a, an episode of the television show “Dexter” is playing on a television, which may also be referred to as a set top box (STB). According to various embodiments, the television show may be presented via any of various techniques. For instance, the television show may be received via a cable television network connection, retrieved from a storage location such as a DVR, or streamed over the Internet from a service provider such as Netflix.

According to various embodiments, the television or an associated device such as a cable box may be capable of communicating information to another device. For example, the television or cable box may be capable of communicating with a server via a network such as the Internet, with a computing device via a local network gateway, or with a computing device directly such as via a wireless network connection. The television or cable box may communicate information such as a current device status, the identity of a media content item being presented on the device, and a user account associated with the device.

At operation 2a, a communication application is activated on a mobile device that is not already operating in companion mode. The communication application may allow the mobile device to establish a communication session for the purpose of entering into a companion mode with other media devices. When in companion mode, the devices may present a connected user interface for cross-device media display. In the example shown in FIG. 16, the communication application is a mobile phone application provided by MobiTV.

At operation 3a, the mobile phone receives a message indicating that the television is active and is playing the episode of the television show “Dexter.” Then, the mobile phone presents a message that provides a choice as to whether to enter companion mode or to dismiss the connection. When the user selects companion mode, the mobile phone initiates the communications necessary for presenting the connected display. For example, the mobile phone may transmit a request to a server to receive the information to display in the connected display.

In particular embodiments, the connected display may present an asset overlay for the content being viewed. For example, the asset overlay may display information related to the viewed content, such as other episodes of the same television program, biographies of the cast members, and similar movies or television shows. In asset overlay user interface may include a screen portion for displaying a small, thumbnail image sized video of the content being presented on the television. Then, the user can continue to watch the television program even while looking at the mobile phone.

In particular embodiments, a device may transmit identification information such as a user account identifier. In this way, a server may be able to determine how to pair different devices when more than one connection is possible. When a device is associated with a user account, the device may display information specific to the user account such as suggested content determined based on the user's preferences.

In some embodiments, a device may automatically enter companion mode when an available connection is located. For instance, a device may be configured in an “auto-companion” mode. When a first device is in auto-companion mode, opening a second device in proximity to the first device causes the first device to automatically enter companion mode, for instance on the asset overlay page. Dismissing an alert message indicating the possibility of entering companion mode may result in the mobile phone returning to a previous place in the interface or in another location, such as a landing experience for a time-lapsed user. In either case, the television program being viewed on the television may be added to the history panel of the communication application.

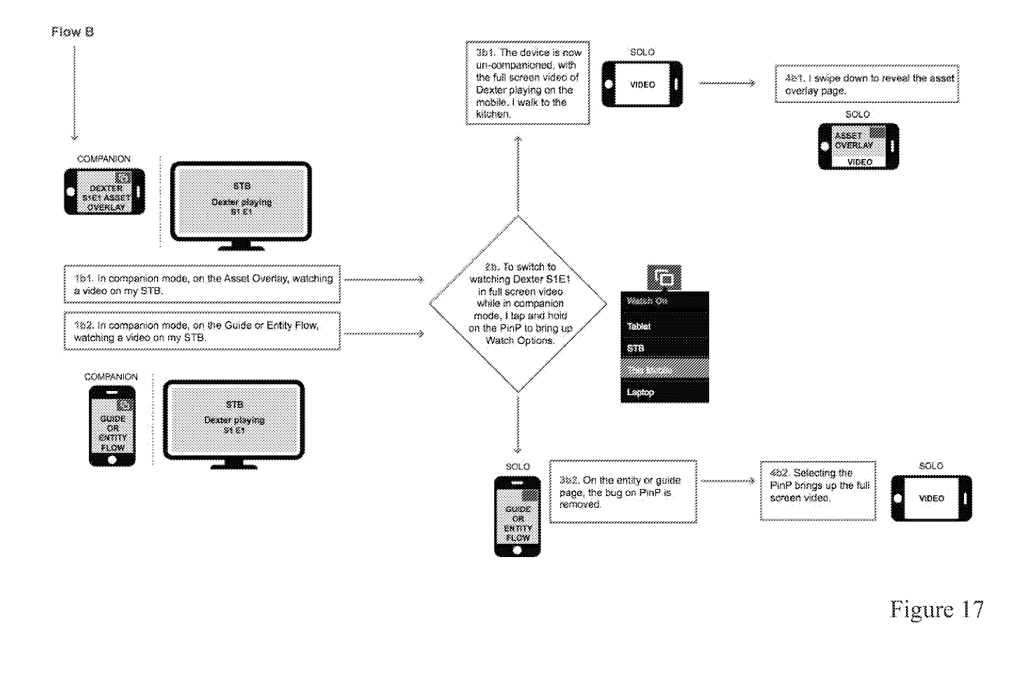

In FIG. 17, techniques are shown for displaying a video in full screen mode on a mobile device while the mobile device is in companion mode. Initially, the television is displaying an episode of the “Dexter” television show. At the same time, the mobile device is operating in companion mode. When the video is displayed in full screen mode, the user can, for instance, take the mobile device to a different location while continuing to view the video.

At operation 1b1, the mobile device is displaying an asset overlay associated with the television program as discussed with respect to FIG. 12. At operation 2b1, the mobile device is displaying an electronic program guide or an entity flow as discussed with respect to FIGS. 13-15. In both operations, the mobile device is also displaying a small, picture-in-picture version of the television show displayed on the television screen.

At operation 2b, the user would like to switch to watching the television program in full screen video on the mobile device while remaining in companion mode. In order to accomplish this task, the user activates a user interface element, for instance by tapping and holding on the picture-in-picture portion of the display screen. When the user activates the selection interface, the mobile device displays a list of devices for presenting the content. At this this point, the user selects the mobile device that the user is operating.

At operation 3b1, the device is removed from companion mode. When companion mode is halted, the video playing on the television may now be presented in the mobile device in full screen. According to various embodiments, the device may be removed from proximity of the television while continuing to play the video.

At operation 4b1, the user selects the asset overlay for display on top of or in addition to, the video. According to various embodiments, various user interface elements may be used to select the asset overlay for display. For example, the user may swipe the touch screen display at the mobile device. As another example, the user may click on a button or press a button on a keyboard.

At operation 3b2, the electronic program guide or entity flow continues to be displayed on the mobile device. At the same time, the “bug” is removed on the picture-in-picture portion of the display screen. As used herein, the term “hug” refers to an icon or other visual depiction. In FIG. 17, the bug indicates that the mobile device is operating in companion mode. Accordingly, the removal of the bug indicates that the device is no longer in companion mode.

At operation 4b2, the video is displayed in full screen mode. According to various embodiments, the video may be displayed in full screen mode by selecting the picture-in-picture interface. Alternately, the video may be automatically displayed in full screen mode when the device is no longer operating in companion mode.

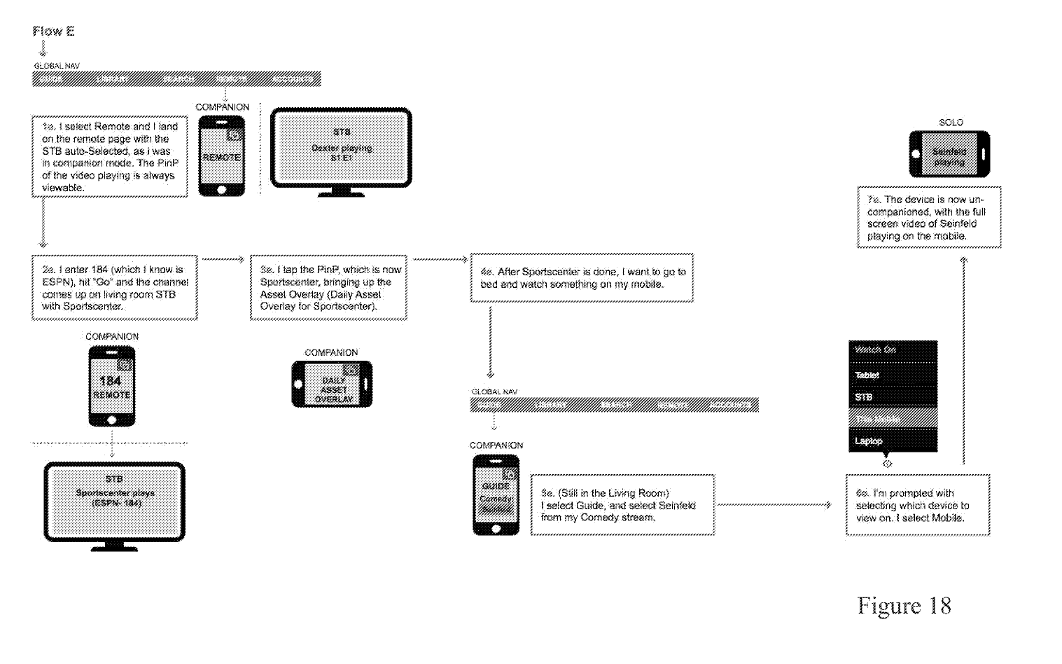

In FIG. 18, the playback of content across different devices is controlled via navigation elements in a connected user interface. According to various embodiments, navigation elements may permit a device to display different user interface components, such as a content guide element, a library element, a search element, a remote control element, and an accounts element. By activating these elements, the user may start or stop the presentation of different media items on different devices, identify new media items for playback, navigate a content guide or library, or perform other operations.

At operation 1e, a television is displaying an episode of the television program “Dexter.” At the same time, a mobile device in companion mode is displaying an asset overlay with related information as well as a small thumbnail video, or picture-in-picture, of the television program. At this point, the user selects the remote element in the navigation component of the user interface. Activation of the remote element brings up the remote user interface. At the remote user interface, the television is automatically selected for control since the mobile device is operating in companion mode.

At operation 2e, the user enters channel number 184 into the remote control user interface element. When the channel number is activated, an instruction is sent to the television or cable box to navigate to the requested channel number. Since the channel corresponds to ESPN, the television program playing on the selected channel is “Sportscenter.” Accordingly, the television switches channels to present the newly selected program.

At operation 3e, the user selects the picture-in-picture portion of the display on the mobile device. In particular embodiments, selecting this display portion activates the asset overlay for the currently playing television show. In this case, the asset overlay may display related content such as descriptions of guests on the show, links to games discussed on the show, and other such sports-related information.

At operation 4e, the “Sportscenter” television program completes. At this point, the user may wish to view a new television program on the mobile device. The user may select the new television program from the mobile device based on the navigation elements.

At operation 5e, the user selects the guide navigation element displayed on the connected user interface. The navigation guide element brings up the navigation guide. At the navigation guide, the user selects a “Seinfeld” television episode from the comedy stream of a customized content guide.

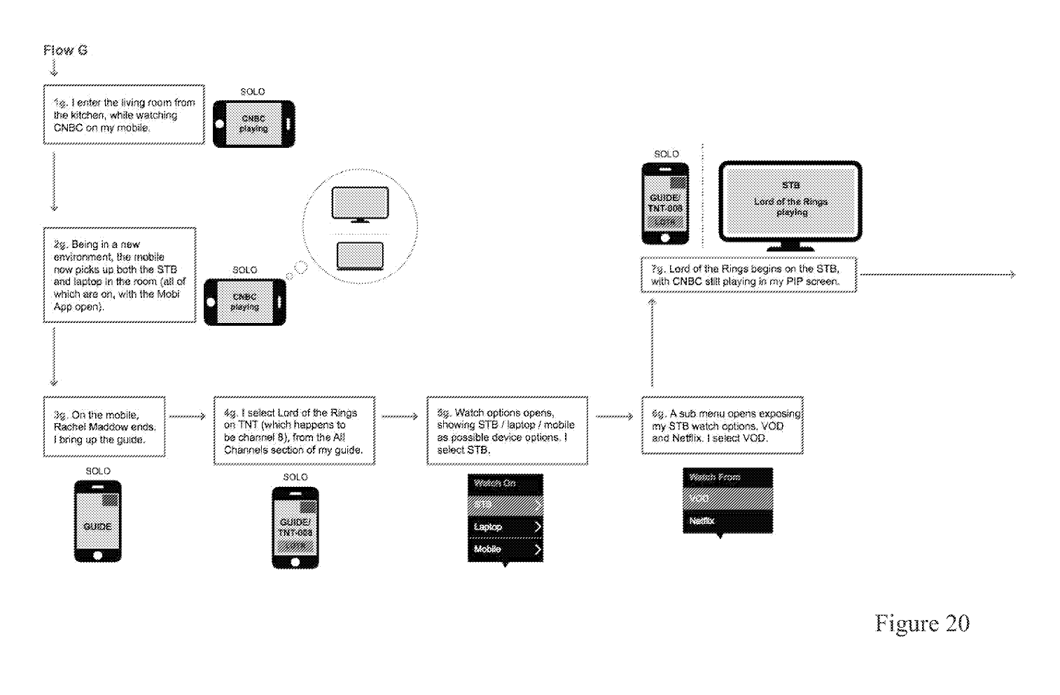

At operation 6e, the mobile device presents a device selection interface for selecting a device on which to view the selected content. In FIG. 20, the selection interface includes options for selecting a tablet computer, the set top box, the mobile device, and a laptop computer. In FIG. 20, the user selects the mobile device for presenting the content.

At operation 7e, the mobile device is no longer in companion mode. In this solo mode, the device presents a full screen video of the selected content. The device no longer displays the connected user interface for interacting with content displayed on the television.

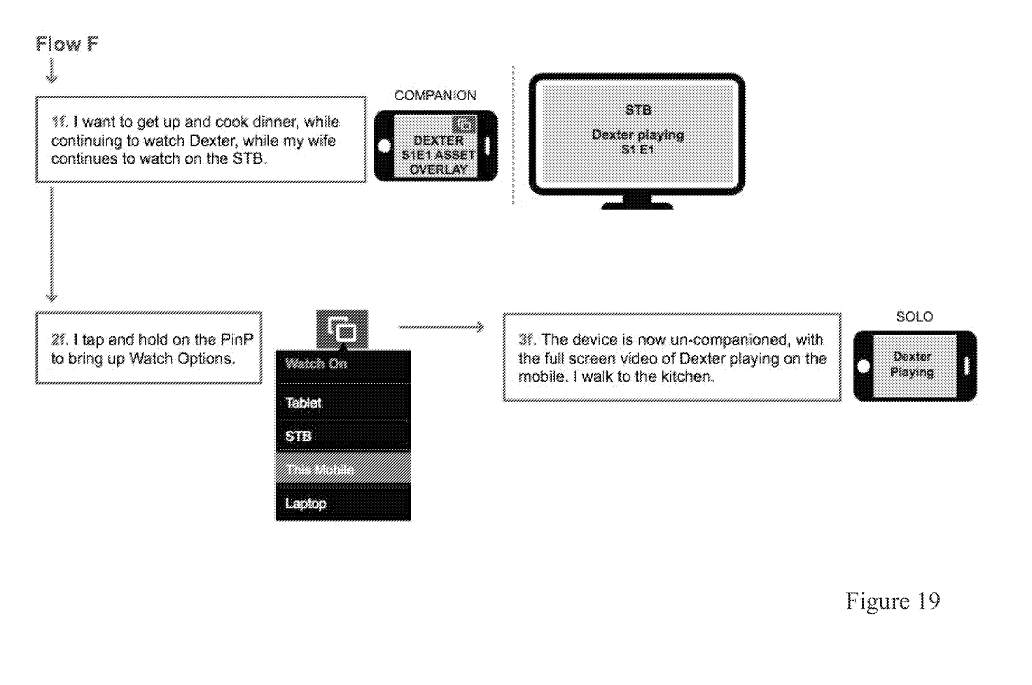

In FIG. 19, media content is configured for display on two devices that begin in companion mode but that move out of range for continuing companion mode. For example, two individuals may be watching a television program on a television screen, with a connected user interface displayed on a mobile device. Then, one user may wish to leave the room while continuing to watch the television program.

At operation if, a television program is being displayed on a television screen. In addition, a mobile device operating in companion mode is displaying a small thumbnail video of the television program along with an asset overlay portion that includes information related to the television program. The two devices may be communicating directly, through a local gateway, or via a server accessible over the Internet.

At operation 2f, the user activates a selection interface for viewing the television program. According to various embodiments, the selection interface may allow the user to select various devices on which to display the media content. In Figure F, those devices include a tablet computer, a set top box, the mobile device being operated by the user, and a laptop computer. In Figure F, the user selects the mobile device.

At operation 3f, the mobile device leaves companion mode and displays the television program independently. At this point, the user may leave the proximity of the television and continue to watch the television program. The mobile device no longer displays the connected user interface and instead displays an interface for controlling the display of content on the mobile device itself.

In FIG. 20-22, various operations are performed via a connected content presentation interface presented on different devices. According to various embodiments, the operations shown in FIGS. 20-22 are examples of the types of operations that may be performed while a user is using the devices to perform common, media-related tasks.

At 1g, a user is viewing the CNBC television channel at a mobile device. According to various embodiments, the CNBC television channel may be presented on the mobile device within a connected user interface that is capable of being used to communicate with other types of media presentation devices. The CNBC television channel may be received via a network such as the Internet from a media content service provider. At 1g, the user is moving within a house while viewing the television program.

At 2g, the mobile device detects the presence of two additional devices, a set top box and a laptop, that enter the proximity of the mobile device as the mobile device is carried through the house. According to various embodiments, the additional devices may be running the connected user interface. In particular embodiments, the connected user interface may be initiated when such device proximity is detected. As discussed herein, the devices may be automatically connected when device proximity is detected or the devices may be connected based on user input.

At 3g, the television program being viewed on the CNBC television channel ends. At this point, user input is received that activates an electronic program guide. The user input may be a button press, mouse click, touch screen display tap, or any other input that the mobile device is capable of receiving. The user input may activate a navigation element such as an on-screen button corresponding to the electronic program guide.

At 4g, user input is received selecting a movie that is playing on a particular television station. The movie is selected from a particular section or view of the guide that shows all available channels. As shown in FIG. 20, the mobile device may continue to display a small scale video stream from the CNBC television channel while the user is browsing the content guide and making the selection.

At 5g, a selection mechanism for identifying watch options is presented on the mobile device. The selection mechanism allows the user to select one or more devices on which to present the selected movie. In FIG. 20, the available devices are those connected with the mobile device, which include the television, the laptop, and the mobile device itself. At this point, the user provides user input selecting the set top box for displaying the movie.

At 6g, an additional selection mechanism is presented on the mobile device for identify a source of the selected movie. In FIG. 20, the user has the option of watching the movie on either video-on-demand, which may be received from a television transmission service provider, or Netflix, which streams selected content via the Internet. In either case, the content may be received via a television cable connection, a television satellite connection, an Internet connection, or any other type of network connection for receiving the content. At this point, the user selects the video-on-demand option.

At 7g, the selected movie received from the selected media content source is presented on the television screen. At the same time, the mobile device continues to present both the content guide from which the movie was selected and a small scale, picture-in-picture video stream from the CNBC television channel. In this way, the user can watch the movie on the television while continuing to perform media-related operations or other operations on the mobile device, all while using a single device to control the media-viewing experience.

As shown in FIGS. 20-22, a connected user interface may be shown on different devices while the devices continue to operate separately in some senses. For instance, the mobile device may be used to control the presentation of content on the television screen. At the same time, the mobile device may present content such as the electronic program guide and the picture-in-picture view of CNBC. Alternately, the mobile device may be configured for companion mode in which it presents information and interfaces related to the content shown on the television screen.

At 8g, the user continues to browse the electronic content guide at the mobile device while the movie plays on the television. For instance, the user may wish to identify media content to view after the movie, media content to view on a different connected device, or media content to view on the mobile device itself.

At 9g, the user identifies a basketball game in the electronic content guide. According to various embodiments, the electronic program guide may emphasize the basketball game based on previously determined user preferences. For instance, user may be known to prefer basketball games in general or the New York Knicks in particular.

According to various embodiments, when a particular media content item is emphasized within the electronic program guide, it may be presented earlier than normal, in a specialized color or font, or otherwise set off from an ordered listing of content or channels. In particular embodiments, an electronic program guide may include customized channels, such as a “New York Knicks” channel, that include content drawn from different sources and that may be presented on different devices. In this way, an electronic program guide may be tailored to the preferences of one or more users.

At 10g, the user selects the identified basketball game. When the game is selected, the user is presented with an interface for selecting a device on which to view the game.

At 11g, the user selects the mobile device itself. Accordingly, the mobile device begins playing the basketball game in place of the previously-presented electronic program guide.

At 12g, the user provides user input activating an asset overlay interface. For instance, the user may swipe downward on a touch screen display interface. When the asset overlay interface is activated, various information related, to the basketball game presented on the mobile device and/or the movie presented on the television is displayed. While the asset overlay interface is presented, the mobile device may continue to show the basketball game in a smaller, picture-in-picture interface.

At 13g, after viewing or interacting with the asset overlay interface for a period of time, the user closes the asset overlay interface. At this point, the mobile device resumes presentation of the basketball game in full screen mode.

At 14g, the movie playing on the set top box finishes playing. At the same time, the basketball game continues to play on the mobile device.

At 15g, the user provides user input, such as a touch screen tap, on the mobile device to activate playhead options. According to various embodiments, the playhead options may provide various choices for affecting the playback of the media content being presented on the mobile device.

At 16g, a user interface is displayed for selecting a playback device for presenting the basketball game currently being shown on the mobile device. Since the movie on the television has finished, the user selects the television for watching the basketball game.

At 17g, the basketball game now appears on the television screen. According to various embodiments, the user can now perform any of various types of operations.

At 18g, the user deactivates the mobile device. At this point, the connected user interface is no longer displayed on the mobile device, and the selected basketball game continues to be shown on the television.

At 19g, instead of deactivating the mobile device, the user provides user input to activate a history panel user interface. According to various embodiments, the history panel user interface includes a list of previously-accessed media content. In the history panel, the user brings up an asset overlay user interface for the basketball game. The asset overlay panel presents information related, to the basketball game, as discussed herein. Additionally, by activating the asset overlay panel and by continuing to present the same content shown on the television screen, the mobile device is placed into companion mode. In particular embodiments, companion mode involves presenting similar or related content on two or more devices via the connected user interface.

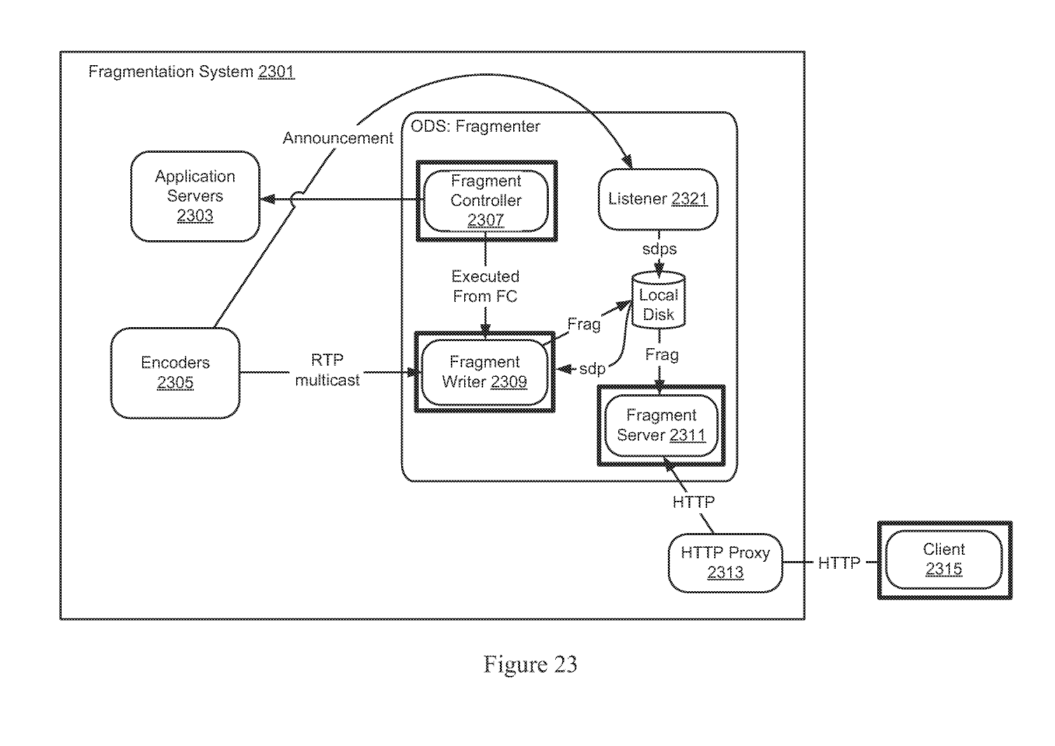

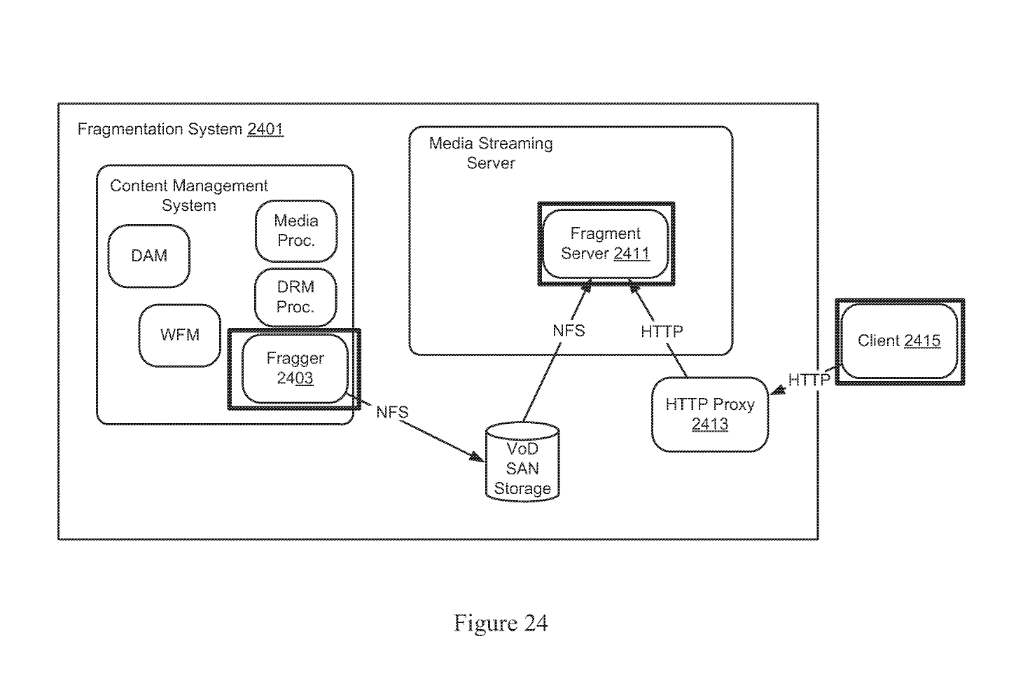

FIG. 23 is a diagrammatic representation illustrating one example of a fragment or segment system 2301 associated with a content server that may be used in a broadcast and unicast distribution network. Encoders 2305 receive media data from satellite, content libraries, and other content sources and sends RTP multicast data to fragment writer 2309. The encoders 2305 also send session announcement protocol (SAP) announcements to SAP listener 2321. According to various embodiments, the fragment writer 2309 creates fragments for live streaming, and writes files to disk for recording. The fragment writer 2309 receives RTP multicast streams from the encoders 2305 and parses the streams to repackage the audio/video data as part of fragmented MPEG-4 files. When a new program starts, the fragment writer 2309 creates a new MPEG-4 file on fragment storage and appends fragments. In particular embodiments, the fragment writer 2309 supports live and/or DVR configurations.

The fragment server 2311 provides the caching layer with fragments for clients. The design philosophy behind the client/server application programming interface (API) minimizes round trips and reduces complexity as much as possible when it comes to delivery of the media data to the client 2315. The fragment server 2311 provides live streams and/or DVR configurations.

The fragment controller 2307 is connected to application servers 2303 and controls the fragmentation of live channel streams. The fragmentation controller 2307 optionally integrates guide data to drive the recordings for a global/network DVR. In particular embodiments, the fragment controller 2307 embeds logic around the recording to simplify the fragment writer 2309 component. According to various embodiments, the fragment controller 2307 will run on the same host as the fragment writer 2309. In particular embodiments, the fragment controller 2307 instantiates instances of the fragment writer 2309 and manages high availability.

According to various embodiments, the client 2315 uses a media component that requests fragmented MPEG-4 files, allows trick—play, and manages bandwidth adaptation. The client communicates with the application services associated with HTTP proxy 2313 to get guides and present the user with the recorded content available.

FIG. 24 illustrates one example of a fragmentation system 2401 that can be used for video-on-demand (VoD) content. Fragger 2403 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 2411 provides the caching layer with fragments for clients. The design philosophy behind the client/server API minimizes round trips and reduces complexity as much as possible when it comes to delivery of the media data to the client 2415. The fragment server 2411 provides VoD content.

According to various embodiments, the client 2415 uses a media component that requests fragmented MPEG-4 files, allows trick-play, and manages bandwidth adaptation. The client communicates with the application services associated with HTTP proxy 2413 to get guides and present the user with the recorded content available.

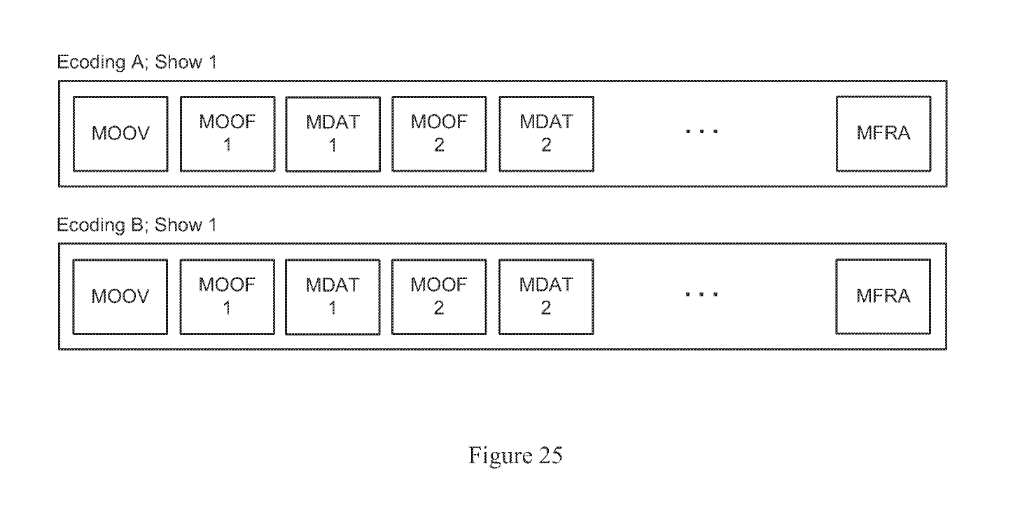

FIG. 25 illustrates examples of files stored by the fragment writer. According to various embodiments, the fragment writer is a component in the overall fragmenter. It is a binary that uses command line arguments to record a particular program based on either NTP time from the encoded stream or wallclock time. In particular embodiments, this is configurable as part of the arguments and depends on the input stream. When the fragment writer completes recording a program, it exits. For live streams, programs are artificially created to be short time intervals e.g. 5-15 minutes in length.

According to various embodiments, the fragment writer command line arguments are the SDP file of the channel to record, the start time, end time, name of the current and next output files. The fragment writer listens to RTP traffic from the live video encoders and rewrites the media data to disk as fragmented MPEG-4. According to various embodiments, media data is written as fragmented MPEG-4 as defined in MPEG-4 part 12 (ISO/IEC 14496-12). Each broadcast show is written to disk as a separate file indicated by the show ID (derived from EPG). Clients include the show ID as part of the channel name when requesting to view a prerecorded show. The fragment writer consumes each of the different encodings and stores them as a different MPEG-4 fragment.

In particular embodiments, the fragment writer writes the RTP data for a particular encoding and the show ID field to a single file. Inside that file, there is metadata information that describes the entire file (MOOV blocks). Atoms are stored as groups of MOOF/MDAT pairs to allow a show to be saved as a single file. At the end of the file there is random access information that can be used to enable a client to perform bandwidth adaptation and trick play functionality.

According to various embodiments, the fragment writer includes an option which encrypts fragments to ensure stream security during the recording process. The fragment writer will request an encoding key from the license manager. The keys used are similar to that done for DRM. The encoding format is slightly different where MOOF is encoded. The encryption occurs once so that it does not create prohibitive costs during delivery to clients.

The fragment server responds to HTTP requests for content. According to various embodiments, it provides APIs that can be used by clients to get necessary headers required to decode the video and seek any desired time frame within the fragment and APIs to watch channels live. Effectively, live channels are served from the most recently written fragments for the show on that channel. The fragment server returns the media header (necessary for initializing decoders), particular fragments, and the random access block to clients. According to various embodiments, the APIs supported allow for optimization where the metadata header information is returned to the client along with the first fragment. The fragment writer creates a series of fragments within the file. When a client requests a stream, it makes requests for each of these fragments and the fragment server reads the portion of the file pertaining to that fragment and returns it to the client.

According to various embodiments, the fragment server uses a REST API that is cache-friendly so that most requests made to the fragment server can be cached. The fragment server uses cache control headers and ETag headers to provide the proper hints to caches. This API also provides the ability to understand where a particular user stopped playing and to start play from that point (providing the capability for pause on one device and resume on another).

In particular embodiments, client requests for fragments follow the following format:

http://{HOSTNAME}/frag/{CHANNEL}/{BITRATE}/[{ID}/]
{COMMAND}[/{ARG}] e.g. http://frag.hosttv.com/frag/1/
H8QVGAH264/1270059632.mp4/fragment/42.

According to various embodiments, the channel name will be the same as the backend-channel name that is used as the channel portion of the SDP file. VoD uses a channel name of “vod”. The BITRATE should follow the BITRATE/RESOLUTION identifier scheme used for RTP streams. The ID is dynamically assigned. For live streams, this may be the UNIX timestamp; for DVR this will be a unique ID for the show; for VoD this will be the asset ID. The ID is optional and not included in LIVE command requests. The command and argument are used to indicate the exact command desired and any arguments. For example, to request chunk 42, this portion would be “fragment/42”.

The URL format makes the requests content delivery network (CDN) friendly because the fragments will never change after this point so two separate clients watching the same stream can be serviced using a cache. In particular, the head end architecture leverages this to avoid too many dynamic requests arriving at the Fragment Server by using an HTTP proxy at the head end to cache requests.

According to various embodiments, the fragment controller is a daemon that runs on the fragmenter and manages the fragment writer processes. A configured filter that is executed by the fragment controller can be used to generate the list of broadcasts to be recorded. This filter integrates with external components such as a guide server to determine which shows to record and which broadcast ID to use.

According to various embodiments, the client includes an application logic component and a media rendering component. The application logic component presents the user interface (UI) for the user, communicates to the front-end server to get shows that are available for the user, and authenticates the content. As part of this process, the server returns URLs to media assets that are passed to the media rendering component.

In particular embodiments, the client relies on the fact that each fragment in a fragmented MP4 file has a sequence number. Using this knowledge and a well-defined URL structure for communicating with the server, the client requests fragments individually as if it was reading separate files from the server simply by requesting URLs for files associated with increasing sequence numbers. In some embodiments, the client can request files corresponding to higher or lower hit rate streams depending on device and network resources.

Since each file contains the information needed to create the URL for the next file, no special playlist files are needed, and all actions (startup, channel change, seeking) can be performed with a single HTTP request. After each fragment is downloaded, the client assesses, among other things, the size of the fragment and the time needed to download, it in order to determine if downshifting is needed or if there is enough bandwidth available to request a higher bit rate.

Because each request to the server looks like a request to a separate file, the response to requests can be cached in any HTTP Proxy, or be distributed over any HTTP based content delivery network CDN.

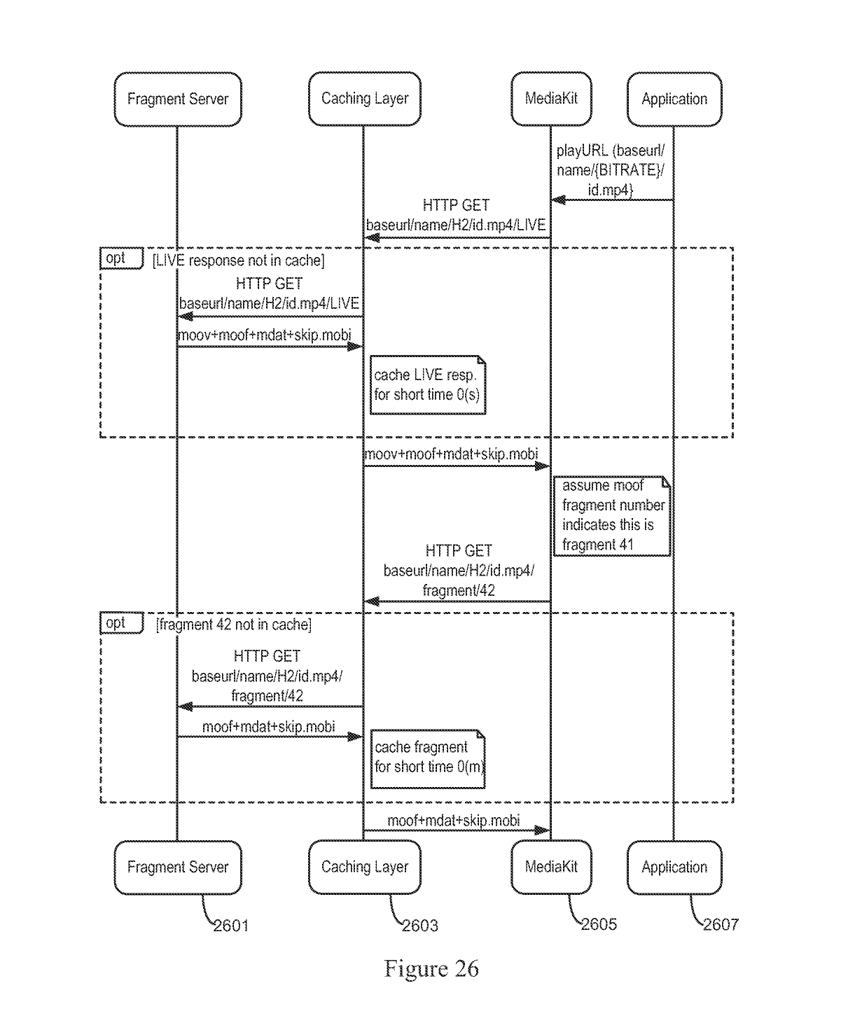

FIG. 26 illustrates an interaction for a client receiving a media stream such as a live stream. The client starts playback when fragment 41 plays out from the server. The client uses the fragment number so that it can request the appropriate subsequent file fragment. An application such as a player application 2607 sends a request to mediakit 2605. The request may include a base address and bit rate. The mediakit 2605 sends an HTTP get request to caching layer 2603. According to various embodiments, the live response is not in cache, and the caching layer 2603 forwards the HTTP get request to a fragment server 2601. The fragment server 2601 performs processing and sends the appropriate fragment to the caching layer 2603 which forwards to the data to mediakit 2605.

The fragment may be cached for a short period of time at caching layer 2603. The mediakit 2605 identifies the fragment number and determines whether resources are sufficient to play the fragment. In some examples, resources such as processing or bandwidth resources are insufficient. The fragment may not have been received quickly enough, or the device may be having trouble decoding the fragment with sufficient speed. Consequently, the mediakit 2605 may request a next fragment having a different data rate. In some instances, the mediakit 2605 may request a next fragment having a higher data rate. According to various embodiments, the fragment server 2601 maintains fragments for different quality of service streams with timing synchronization information to allow for timing accurate playback.

The mediakit 2605 requests a next fragment using information from the received fragment. According to various embodiments, the next fragment for the media stream may be maintained on a different server, may have a different bit rate, or may require different authorization. Caching layer 2603 determines that the next fragment is not in cache and forwards the request to fragment server 2601. The fragment server 2601 sends the fragment to caching layer 2603 and the fragment is cached for a short period of time. The fragment is then sent to mediakit 2605.

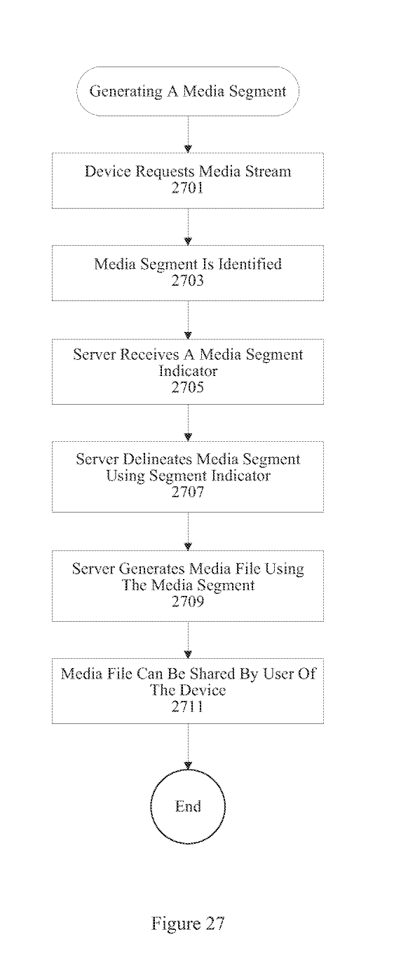

FIG. 27 illustrates a particular example of a technique for generating a media segment. According to various embodiments, a media stream is requested by a device at 2701. The media stream may be a live stream, media clip, media file, etc. The request for the media stream may be an HTTP GET request with a baseurl, bit rate, and file name. At 2703, the media segment is identified. According to various embodiments, the media segment may be a 35 second sequence from an hour long live media stream. The media segment may be identified using time indicators such as a start time and end time indicator. Alternatively, certain sequences may include tags such as fight scene, car chase, love scene, monologue, etc., that the user may select in order to identify a media segment. In still other examples, the media stream may include markers that the user can select. At 2705, a server receives a media segment indicator such as one or more time indicators, tags, or markers. In particular embodiments, the server is a snapshot server, content server, and/or fragment server. According to various embodiments, the server delineates the media segment maintained in cache using the segment indicator at 2707. The media stream may only be available in a channel buffer. At 2709, the server generates a media file using the media segment maintained in cache. The media file can then be shared by a user of the device at 2711. In some examples, the media file itself is shared while in other examples, a link to the media file is shared.

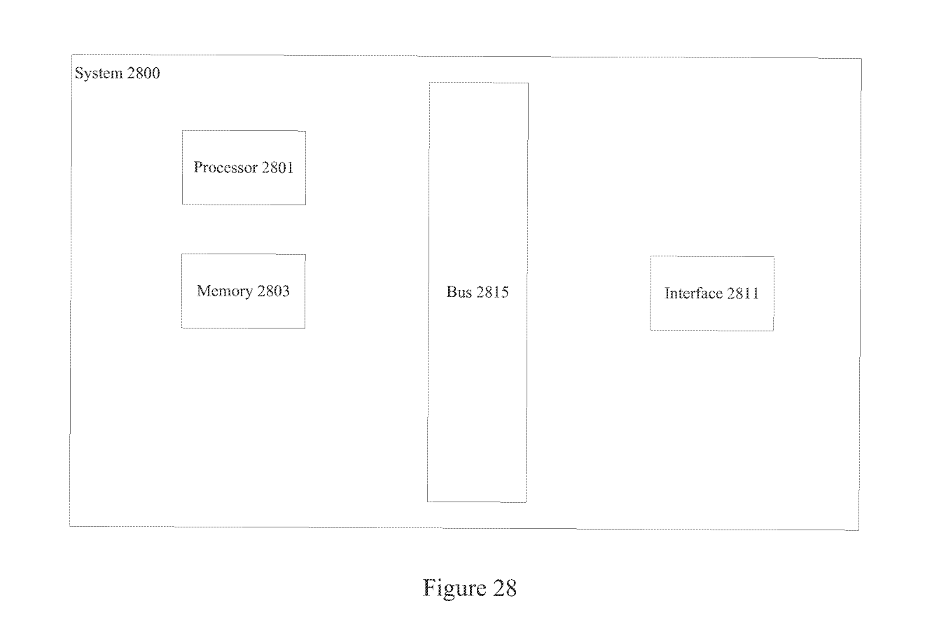

FIG. 28 illustrates one example of a server. According to particular embodiments, a system 2800 suitable for implementing particular embodiments of the present invention includes a processor 2801, a memory 2803, an interface 2811, and a bus 2815 (e.g., a PCI bus or other interconnection fabric) and operates as a streaming server. When acting under the control of appropriate software or firmware, the processor 2801 is responsible for modifying and transmitting live media data to a client. Various specially configured devices can also be used in place of a processor 2801 or in addition to processor 2801. The interface 2811 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSST interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 2800 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A system comprising:
a media presentation server including a processor and memory, the media presentation server being operable to transmit information for generating a media presentation interface at a plurality of media presentation devices, the media presentation interface operable to navigate and display media content; and
a first and a second media presentation device, each media presentation device including a processor, memory, and a display screen, each media presentation device being operable to generate the media presentation interface based on the information received from the media presentation interface server, the second media presentation device being operable to update the media presentation interface based on an instruction received from the first media presentation device.

2. The system recited in claim 1, wherein the instruction indicates a media content item to display on the display screen at the second media presentation device.

3. The system recited in claim 1, wherein the media presentation interface at the second media presentation device is configured to display a media content item, and wherein the media presentation interface at the first media presentation device is configured to display contextual information regarding the media content item.

4. The system recited in claim 3, wherein the media presentation interface at the first media presentation device is further configured to display the media content item on a portion of the display screen.

5. The system recited in claim 1, wherein the second media presentation device is operable to receive and present a television transmission, and wherein the instruction comprises a designated television channel to present at the second media presentation device.

6. The system recited in claim 1, wherein the media presentation interface at the first media presentation device is operable to receive user input designating a device at which to present a media content item.

7. The system recited in claim 1, wherein the first media presentation device is operable to receive user input designated a source from which to receive media content for presentation at the first media presentation device.

8. The system recited in claim 1, wherein the media presentation interface includes a media content playback interface portion, a media content history interface portion, an electronic content guide interface portion, and a media item navigation interface portion.

9. The system recited in claim 1, wherein each of the first and second media presentation devices is a device selected from the group consisting of: a tablet computer, a laptop computer, a desktop computer, a mobile phone, and a television.

10. A method comprising:
transmitting, from a server, a first instruction for presenting a first media content interface on a first media presentation device, the first media presentation device being associated with a user account;
transmitting, from the server, a second instruction for presenting a second media content interface on a second media presentation device, the second media presentation device being associated with a user account;
receiving, from the first media presentation device, a third instruction for updating the second media content interface; and
based on the third instruction, transmitting a fourth instruction for updating the second media content interface to the second media presentation device.

11. The method recited in claim 10, wherein the third instruction designates a media content item to display on the display screen at the second media presentation device, and wherein updating the second media content interface comprises displaying the designated media content item.

12. The method recited in claim 10, wherein the second media presentation interface is configured to display a media content item, and wherein the first media presentation interface is configured to display contextual information regarding the media content item.

13. The method recited in claim 12, wherein the first media presentation interface is further configured to display the media content item on a portion of the display screen.

14. The method recited in claim 10, wherein the second media presentation device is operable to receive and present a television transmission, and wherein the instruction comprises a designated television channel to present at the second media presentation device.

15. The method recited in claim 10, wherein the first media presentation device is operable to receive user input designating a device at which to present a media content item.

16. The method recited in claim 10, wherein the first media presentation device is operable to receive user input designated a source from which to receive media content for presentation at the first media presentation device.

17. One or more computer readable media having instructions stored thereon for performing a method, the method comprising:
transmitting, from a server, a first instruction for presenting a first media content interface on a first media presentation device, the first media presentation device being associated with a user account;
transmitting, from the server, a second instruction for presenting a second media content interface on a second media presentation device, the second media presentation device being associated with a user account;
receiving, from the first media presentation device, a third instruction for updating the second media content interface; and
based on the third instruction, transmitting a fourth instruction for updating the second media content interface to the second media presentation device.

18. The one or more computer readable media recited in claim 17, wherein the third instruction designates a media content item to display on the display screen at the second media presentation device, and wherein updating the second media content interface comprises displaying the designated media content item.

19. The one or more computer readable media recited in claim 17, wherein the second media presentation interface is configured to display a media content item, and wherein the first media presentation interface is configured to display contextual information regarding the media content item.

20. The one or more computer readable media recited in claim 19, wherein the first media presentation interface is further configured to display the media content item on a portion of the display screen.
